(19) United States
(12) Patent Application Publication
(10) Pub. No.: US 2013/0176121 A1
(43) Pub. Date: Jul. 11, 2013

(54) AUTOMOTIVE LIGHT ASSEMBLY

(71) Applicant: Tsung-Shueh TSAI, Tainan City (TW)

(72) Inventor: Tsung-Shueh TSAI, Tainan City (TW)

(73) Assignee: CHENG QU CO., LTD., Tainan City (TW)

(21) Appl. No.: 13/344,669

(22) Filed: Jan. 6, 2012

(51) Int. Cl. B60Q 1/34

(52) U.S. Cl. 340/475

(57) ABSTRACT

An automotive light assembly is revealed. The automotive light assembly includes a controller that is electrically connected to a daytime running light switch and a turn signal light switch of a vehicle. The controller is connected to each light source of a daytime running light set by at least one control cable. The controller is also connected to each light source of a turn signal light set by a plurality of control cables, allowing each light source emitting light in turn for indicating directions of vehicle movement. Thus not only the structure of the automotive light assembly is simplified and the production cost is dramatically reduced. By means of light from each light source of the turn signal light set, the direction the vehicle will be turned is indicated more precisely so as to achieve better warning effect and higher safety.

### BACKGROUND OF THE INVENTION

1. Field of the Invention

The present invention relates to an automotive light assembly, especially to an automotive light assembly with simple structure and reduced manufacturing cost. While in use, the direction of the vehicle movement can be indicated precisely by the automotive light assembly so as to provide better warning effect and higher safety. The automotive light assembly is of higher practical value.

2. Description of Related Art

Generally, there are various types of lights arranged at different positions of vehicles such as head lights, daytime running lights, tail lights, turn signal lights, stop lights, etc. Under different conditions, lights on the different positions emit light for reminding drivers or pedestrians to notice the coming cars or the vehicle movement. At the same time, when the drivers drive in a dark place or at night, the visibility is dramatically improved by the lights so as to ensure the traffic safety.

The above vehicle lights provide expected effect. However, while in use, daytime running lights are usually used as warning lights and turn signal lights are used to indicate the direction of a vehicle that is shifting lanes or turning. The two types of lights have different functions as well as different colors. Thus they are two sets of lights each of which having corresponding light holders, light sources, reflectors and light covers. Thus the light has complicated structure and the assembling of the light is inconvenient. Moreover, the manufacturing cost is also high.

Thus there is room for improvement and a need to provide a novel design of the automotive light assembly having higher practical value.

### SUMMARY OF THE INVENTION

Therefore it is a primary object of the present invention to provide an automotive light assembly with simple structure and reduced manufacturing cost. Moreover, the direction the vehicle is going to be turned is indicated more precisely by the automotive light assembly so that better warning effect and higher safety are achieved.

In order to achieve the above object, an automotive light assembly of the present invention includes a controller that is electrically connected to a daytime running light switch and a turn signal light switch of a vehicle. The controller is connected to each light source of a daytime running light set by at least one control cable. The controller is also connected to each light source of a turn signal light set by a plurality of control cables, allowing each light source of the turn signal light set emitting light in turn for indicating directions of vehicle movement.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment according to the present invention;

FIG. 2 is a schematic drawing showing structure of another embodiment according to the present invention.

### DETAILED DESCRIPTION OF THE PREFERRED EMBODIMENT

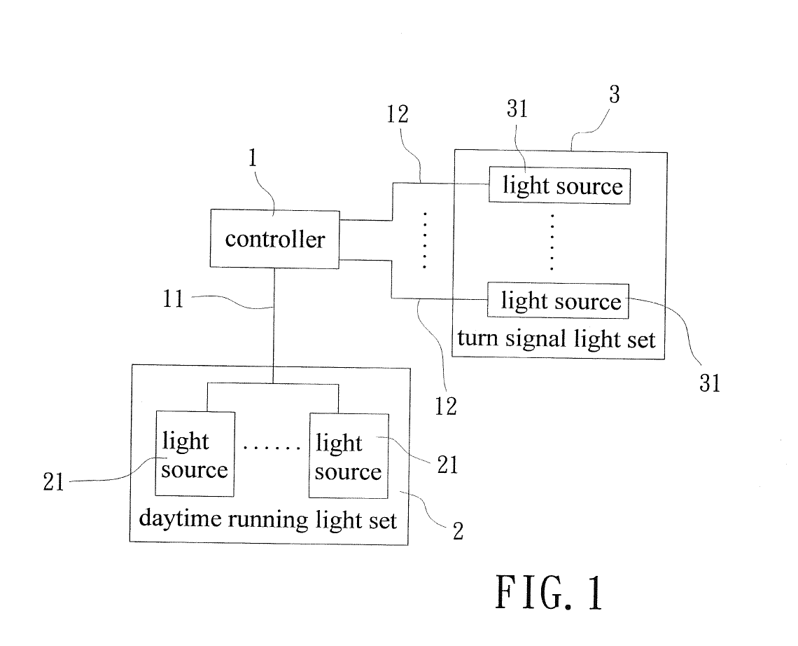

Refer to FIG. 1, an embodiment of the present invention mainly includes a controller 1. The controller 1 is electrically connected to a daytime running light switch and a turn signal light switch of a vehicle. The controller 1 is connected to each light source 21 of a daytime running light set 2 by at least one control cable 11 and is also connected to each light source 31 of a turn signal light set 3 by a plurality of control cables 12. The light source 21 of the daytime running light set 2 as well as the light source 31 of the turn signal light set 3 is a light emitting diode that emits light independently or one of two light emitting chips with different colors.

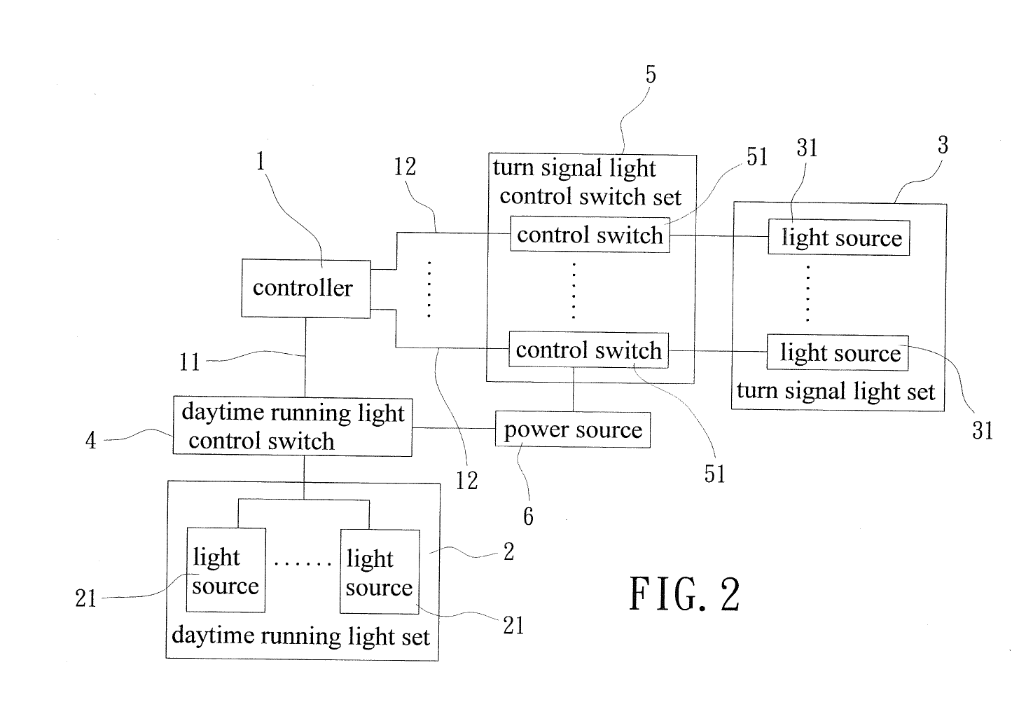

Moreover, refer to FIG. 2, another embodiment is revealed. A daytime running light control switch 4 is arranged between a controller 1 and a daytime running light set 2. A turn signal light control switch set 5 is disposed between the controller 1 and the turn signal light set 3. The daytime running light control switch 4 and the turn signal light control switch set 5 are respectively connected to a power source 6. The controller 1 is connected to the daytime running light control switch 4 by a control cable 11 and then the power source 6 is connected to each light source 21 of the daytime running light set 2 through the daytime running light control switch 4. Moreover, the controller 1 is connected to each control switch 51 of the turn signal light control switch set 5 by a plurality of control cables 12 and then the power source 6 is connected to each light source 31 of the turn signal light set 3 through each control switch 51 of the turn signal light control switch set 5.

While in use, the controller 1 makes each light source 21 of the daytime running light set 2 emit light by the control cable 11 after the daytime running light being turned on. Or the controller 1 controls on/off of the daytime running light control switch 4 by the control cable 11, allowing power from the power source 6 being transmitted to each light source 21 of the daytime running light set 2 through the daytime running light control switch 4. Thus each light source 21 emits light so as to provide warning effects. When the driver want to make a turn and turn on a turn signal light switch corresponding to that direction, the controller 1 simultaneously controls each light source 31 of the turn signal light set 3 to emit light by each control cable 12. Or the controller 1 turns on each control switch 51 the turn signal light control switch set 5 in sequence by the corresponding control cable 12. Thus power from the power source 6 is transmitted to each light source 31 of the turn signal light set 3 through each control switch 51 of the turn signal light control switch set 5 respectively. Each light source 31 emits light in turn so as to indicate the direction the driver will turn.

In summary, compared with the structure available now, the present invention not only simplifies structure of the automotive light assembly for dramatically reduction of the manufacturing cost but also make each light source of the turn signal light set emit light for indicating turning direction of the car more precisely. Thus better warning effect and higher safety are provided. The automotive light assembly of the present invention is of higher practical value.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An automotive light assembly comprising at least one controller that is electrically connected to a daytime running light switch and a turn signal light switch of a vehicle; the controller is connected to each light source of a daytime running light set by at least one control cable; the controller is also connected to each light source of a turn signal light set by a plurality of control cables; each light source emits light in turn under control of the controller for indicating directions of vehicle movement.

2. The device as claimed in claim 1, wherein the light source of the daytime running light set is light emitting diode.

3. The device as claimed in claim 1, wherein the light source of the turn signal light set is light emitting diode.

4. The device as claimed in claim 1, wherein the light source of the daytime running light set and the light source of the turn signal light set respectively are two light emitting chips with different colors.

5. The device as claimed in claim 1, wherein a daytime running light control switch is arranged between the controller and the daytime running light set; the daytime running light control switch is connected to a power source; the controller is connected to the daytime running light control switch by the control cable and then the power source is connected to each light source of the daytime running light set through the daytime running light control switch.

6. The device as claimed in claim 1, wherein a turn signal light control switch set is disposed between the controller and the turn signal light set; the turn signal light control switch set is connected to a power source; the controller is connected to each control switch of the turn signal light control switch set by a plurality of control cables and then the power source is connected to each light source of the turn signal light set through each control switch of the turn signal light control switch set.
